(19) United States
(12) Patent Application Publication
(10) Pub. No.: US 2019/0346280 A1
(43) Pub. Date: Nov. 14, 2019

(54) APPARATUSES AND METHODS FOR CORRECTING ORIENTATION INFORMATION FROM ONE OR MORE INERTIAL SENSORS

(71) Applicant: FRAUNHOFER-GESELLSCHAFT ZUR FOERDERUNG DER ANGEWAN, Munich (DE)

(72) Inventors: Christopher MUTSCHLER, Erlangen (DE); Tobias FEIGL, Erlangen (DE)

(21) Appl. No.: 16/461,435

(22) PCT Filed: Jan. 3, 2018
(86) PCT No.: PCT/EP2018/050129

§ 371 Date: May 16, 2019

(30) Foreign Application Priority Data
Jan. 13, 2017 (DE) 10 2017 100 622.2

(51) Int. Cl. G01C 25/00; G01C 21/16; G06N 20/00

(52) U.S. Cl. CPC G01C 25/00; G06N 20/00; G01C 21/16

(57) ABSTRACT

The present disclosure relates to a concept for correcting orientation information based on inertial sensor data from one or more inertial sensors mounted to an object. The proposed concept includes receiving position data indicative of a current absolute position of the object, determining a direction of movement of the object based on the position data, and correcting the object's orientation information based on the determined direction of movement.

### FIELD

The present disclosure generally relates to adjusting inaccurate position and/or orientation information obtained via relative motion sensors. This can be useful in the field of Virtual Reality (VR), for example.

### BACKGROUND

Virtual Reality (VR) drives innovation in a wide range of applications including theme parks, museums, architecture, training, and simulation. All of them benefit from multi-user interaction and large scale areas that are larger than 25 m×25 m, for example. Today's state-of-the-art VR systems mostly use camera-based motion tracking. However, tracking accuracy decreases with the camera resolution and the environment size, and tracking more users needs more cameras to avoid occlusion. The cost of those systems grows exponentially with the number of users and the size of the tracking area. Instead, room-scale tracking is available for a few hundred dollars.

Conceptually, so-called No-Pose (NP) tracking systems that only track single positions per user/object instead of the complete pose (position and orientation) can work with larger tracking areas and more users at significantly lower total cost. NP tracking systems can be based on Radio Frequency (RF) tracking systems, for example. But there are a number of technical obstacles that still limit their applicability. Most importantly, in contrast to camera-based motion capturing systems (that provide the full pose), NP tracking systems only provide single positions per object that cannot be combined to derive the pose as tracking accuracy is insufficient. Hence, an object's orientation (such as a head's orientation with respect to a user's body, for example) has to be estimated separately.

Current low-cost Head-Mounted Display (HMD) units are equipped with local Inertial Measurement Units (IMU) such as accelerometers, gyroscopes, and magnetometers that can be used to estimate the object's orientation (e.g., head orientation). This on-client processing can also reduce latency, which is a serious problem of pose estimation camera-based systerns. Reducing latency in VR systems can significantly improve immersion.

But in practice IMU-based orientation estimation is far from accurate because of a number of reasons. First, as magnetometers are unreliable in many indoor and magnetic environments, they often provide a wrong absolute orientation. Second, dead reckoning, based on relative IMU data leads to drift and (after a while) to a wrong orientation estimation. In navigation, dead reckoning or dead-reckoning is known as a process of calculating one's current position by using a previously determined position and advancing that position based upon known or estimated speeds over elapsed time and course. Third, state-of-the-art orientation filters fail, as the low-cost sensors of the HMD provide unreliable motion direction estimates. Fourth, besides sensor noise, rotations (such as head rotations, for example) make it impossible to reliably estimate the linear and gravity components of the acceleration while moving and turning the object. However, linear acceleration components are necessary to estimate a movement direction, displacement and/or position.

A wrong orientation estimation can result in a significant mismatch of the real world and a VR display. The upper row in FIG. 1 shows the view of a user who walks straight ahead with his/her head oriented in the direction of the movement. This movement should lead through the middle of the pillars 101, 102 in the middle row (no drift), which shows the user's virtual view. However, under drift (the bottom row shows a 45° heading offset) the same movement leads to a displacement from right to left as a wrong head orientation \vec{v} is used to render the images. For the user the direction of the movement does not fit to the VR view. This can cause motion sickness.

FIG. 2 shows the relation between a real object R and a virtual object V and both real \vec{r} and virtual \vec{v} view directions. The real movement direction hi, represents the user walking straight forward towards the real object R. Whereas, the user experiences the virtual object V to pass by rightwards. From the real world's perspective (where R is placed), the virtual object V does no longer match to its real world counterpart R, as they are rotated by the drift value. It has been found that as the drift increases motion sickness also increases.

Thus, it is desirable to better align the sensor based orientation or view direction \vec{v} with the real orientation or view direction \vec{r}.

### SUMMARY

An idea of the present disclosure is to combine positional tracking with relative IMU data to achieve a long-time stable object orientation while a user or object is naturally moving (e.g., walking and rotating his/her head).

According to one aspect of the present disclosure, it is provided a method for correcting orientation information which is based on inertial sensor data from one or more inertial sensors mounted to an object. The object can in principle be any kind of animate or inanimate movable or moving object having one or more IMUs mounted thereto. For example, the object can be a human head or a HMD in some examples. The sensor data can comprise multi-dimensional acceleration data and/or multi-dimensional rotational velocity data in some examples. The method includes receiving position data indicative of a current absolute position of the object. In some examples, the position data can be indicative of a single absolute position of the object stemming from a NP tracking system. The method also includes determining a direction of movement of the object based on the position data and correcting the object's orientation information based on the determined direction of movement.

In example applications related to VR, the object's orientation information, which is based on inertial sensor data, can also be considered as the object's virtual orientation, which might differ from its real orientation due to sensor inaccuracies.

In some examples, the object's orientation information may be indicative of rotational orientation around the object's (e.g., a user's head) yaw axis. Various objects are free to rotate in three dimensions: pitch (up or down about an axis running horizontally), yaw (left or right about an axis running vertically), and roll (rotation about a horizontal axis perpendicular to the pitch axis). The axes can alternatively be designated as lateral, vertical, and longitudinal. These axes move with the object and rotate relative to the earth along with the object. A yaw rotation is a movement around the yaw axis of a rigid body that changes the direction it is pointing, to the left or right of its direction of motion. The yaw rate or yaw velocity of an object is the angular velocity of this rotation. It is commonly measured in degrees per second or radians per second.

In some examples, the direction of movement can be determined based on position data corresponding to subsequent time instants. The position data can be indicative of a 2- or 3-dimensional position (x, y, z) of the object and can be provided by a position tracking system. Based on a first multi-dimensional position at a first time instant and a second multi-dimensional position at a subsequent second time instant it is possible to derive a current or instantaneous multi-dimensional motion vector pointing from the first position to the second position.

In some examples, correcting the object's orientation information can include estimating, based on the sensor data, a relationship between a real orientation of the object and the object's (real) direction of movement. If the estimated relationship indicates that the object's real orientation (e.g., user's head orientation) corresponds to the object's real direction of movement, the object's orientation information can be corrected based on the determined real direction of movement.

In some examples, assuming that animate objects, such as humans, mostly walk towards their viewing direction, correcting the object's orientation information can include corresponding the object's orientation information with the object's direction of movement. As such, an inaccurate orientation estimate provided by the one or more IMUs can be aligned with the object's measured (real) direction of movement.

In some examples, the method can further optionally comprise preprocessing the sensor data with a smoothing filter to generate smoothed sensor data. An example of such a smoothing filter would be a Savitzky-Golay filter, which is a digital filter that can be applied to a set of digital data points for the purpose of smoothing the data, that is, to increase the signal-to-noise ratio without greatly distorting the signal. This can be achieved, in a process known as convolution, by fitting successive sub-sets of adjacent data points with a low-degree polynomial by the method of linear least squares.

In some examples, the method can further optionally comprise filtering the (smoothed) sensor data with a low pass filter and/or a high pass filter. In some applications this can be beneficial to avoid or reduce unwanted sensor signal components, such as acceleration signal components related to gravity, for example.

In some examples, estimating the relationship between the object's real orientation and the object's (real) direction of movement can further include compressing the (filtered) sensor data. In signal processing, data compression involves encoding information using fewer bits than the original representation. Compression can be either lossy or lossless. Lossless compression reduces bits by identifying and eliminating statistical redundancy. No information is lost in lossless compression. Lossy compression reduces bits by removing unnecessary or less important information. The process of reducing the size of data is referred to as data compression.

In some examples, compressing the sensor data can include extracting one or more statistical and/or heuristic features from the sensor data to generate sensor data feature vectors. Such features can include domain specific features, such as time domain features (e.g., mean, standard deviation, peaks) or frequency domain features (e.g., FFT, energy, entropy), heuristic features (e.g., signal magnitude area/vector, axis correlation), time-frequency-domain features (e.g., wavelets), domain-specific features (e.g., gait detection).

Although a variety of statistical and/or heuristic features is principally possible, compressing the sensor data can comprise extracting a mean value, standard deviation, and can comprise a Principal Component Analysis (PCA) of the sensor data in some examples. As such, numerous sensor data samples can be reduced to only one or a few samples representing the statistical and/or heuristic features. PCA is a statistical procedure that uses an orthogonal transformation to convert a set of observations of possibly correlated variables into a set of values of linearly uncorrelated variables called principal components. The number of principal components is less than or equal to the number of original variables. This transformation is defined in such a way that the first principal component has the largest possible variance (that is, accounts for as much of the variability in the data as possible), and each succeeding component in turn has the highest variance possible under the constraint that it is orthogonal to the preceding components. The resulting vectors are an uncorrelated orthogonal basis set.

In some examples, estimating the relationship between the object's real orientation and the object's real direction of movement can further include classifying the relationship based on the compressed sensor data and generating a statistical confidence with respect to the classification result. In machine learning and statistics, classification is referred to as the problem of identifying to which of a set of categories a new observation belongs, on the basis of a training set of data containing observations (or instances) whose category membership is known. Example categories can be indicative of the relationship between the object's real orientation and the object's real direction of movement, such as “head right while moving forward”, “head left while moving forward”, or “head straight while moving forward”. In the terminology of machine learning, classification is considered an instance of supervised learning, i.e. learning where a training set of correctly identified observations is available. Often, the individual observations are analyzed into a set of quantifiable properties, known variously as explanatory variables or features.

Classifying the relation between the object's real orientation and the object's real direction of movement can be performed by a variety of classification algorithms, such as, for example a Support Vector Machine (SVM). In machine learning, SVMs are supervised learning models with associated learning algorithms that analyze data used for classification and regression analysis. Given a set of training examples, each marked as belonging to one or the other of two categories, an SVM training algorithm builds a model that assigns new examples to one category or the other, making it a non-probabilistic binary linear classifier. An SVM model is a representation of the examples as points in space, mapped so that the examples of the separate categories are divided by a clear gap that is as wide as possible. New examples are then mapped into that same space and predicted to belong to a category based on which side of the gap they fall. In addition to performing linear classification, SVMs can efficiently perform a non-linear classification using what is called the kernel trick, implicitly mapping their inputs into high-dimensional feature spaces. When data are not labeled, supervised learning is not possible, and an unsupervised learning approach is required, which attempts to find natural clustering of the data to groups, and then map new data to these formed groups. The clustering algorithm which provides an improvement to the SVMs is called support vector clustering and is often used in industrial applications either when data are not labeled or when only some data are labeled as a preprocessing for a classification pass.

In some examples, the statistical confidence of the classification can further be verified based on predetermined physical properties or limitations of the object. For example, a human often looks into the direction he/she is moving. Also, a human is not capable of turning his/her head from left to right, or vice versa, within certain short time periods. For example, if two subsequent estimation or prediction periods are within 100-250 ms, and both predictions yield contradicting results with respect to head orientation, their respective confidence level can be lowered.

In some examples, an error of the object's orientation information can be corrected incrementally or iteratively. That is to say, the error can be divided into smaller portions which can be applied to the VR over time. In VR applications, this can reduce or even avoid so-called motion sickness. In some examples, spherical linear interpolation (SLERP) can be used to correct the error.

In some examples, the method can include a live as well as a training mode. During training mode a supervised learning model (such as e.g. SVM) may be trained for classifying a relation between a real orientation of the object and the object's real direction of movement based on training sensor data corresponding to a predefined relation between a predefined real orientation and a predefined real direction of movement of the object.

According to a further aspect of the present disclosure it is provided an apparatus for correcting orientation information based on inertial sensor data from one or more inertial sensors mounted to an object. The apparatus, when operational, can perform methods according to the present disclosure. It comprises an input configured to receive position data indicative of a current absolute position of the object and processing circuitry configured to determine a direction of movement of the object based on the position data and to correct the object's orientation information based on the determined direction of movement.

Thus, some examples propose to combine positional tracking with relative IMU data to achieve a long-time stable object (e.g. head) orientation while the user is naturally moving (e.g. walking and rotating his/her head). Under the assumption that humans mostly walk towards their viewing direction, some examples propose to extract features from the sensor signals, classify the relation between real movement direction (e.g., of the body) and real object (e.g. head) orientation, and combine this with absolute tracking information. This then yields the absolute head orientation that can be used to adapt the offsets into a user's virtual view. The fact that humans tend to walk and look into the same direction can be further exploited to reduce classification errors by constituting a high probability of forward movement and view direction.

### BRIEF DESCRIPTION OF THE FIGURES

Some examples of apparatuses and/or methods will be described in the following by way of example only, and with reference to the accompanying figures, in which

FIG. 1 shows a visualization of a view in real (top) and virtual (mid and bottom) world;

FIG. 2 illustrates a straight real forward movement that results in related virtual sidewards movement of a rendered image based on orientation drift;

FIG. 3 illustrates an example of head orientation drift: offset θ between unknown real head orientation \vec{r} and virtual head orientation \vec{v} and offset ω between viewing direction \vec{r} and movement direction \vec{m};

FIG. 4 shows a flowchart of a method for correcting orientation information according to an example of the present disclosure;

FIG. 5 shows a block diagram of an apparatus for correcting orientation information according to an example of the present disclosure;

FIG. 6 show raw and (Low-Pass (LP), High-Pass (HP)) filtered acceleration signals;

FIG. 7 show linear accelerations, IIR (LP,HP) filtered and raw gyroscope data;

FIG. 8 shows a block diagram of sensor signal preprocessing;

FIG. 9 shows an example of a history-based confidence optimization process;

FIG. 10 shows a block diagram of sensor signal processing comprising feature extraction and classification;

FIG. 11 shows a block diagram of sensor signal post-processing; and

FIG. 12 shows a block diagram of a compete sensor signal processing chain.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

Although the principles of the present disclosure will be mainly exemplified in the context of VR in the following, the skilled person having benefit from the present disclosure will appreciate that these principles can also straightforwardly be translated to numerous other fields of technology where sensor data can be used to provide orientation information of an animate or inanimate movable object. In case of IMUs, the relative sensor data will inevitably lead to error accumulation over time and thus needs to be corrected now and then. The present disclosure proposes a concept for such correction by combining the IMU sensor data with positions or position tracking data.

As absolute sensors (such as magnetometers) do not work reliably in practice, only relative movement estimation sensors can be exploited. For HMDs used in VR applications, for example, this inevitably leads to a wrong head orientation in the long-term due to sensor drift.

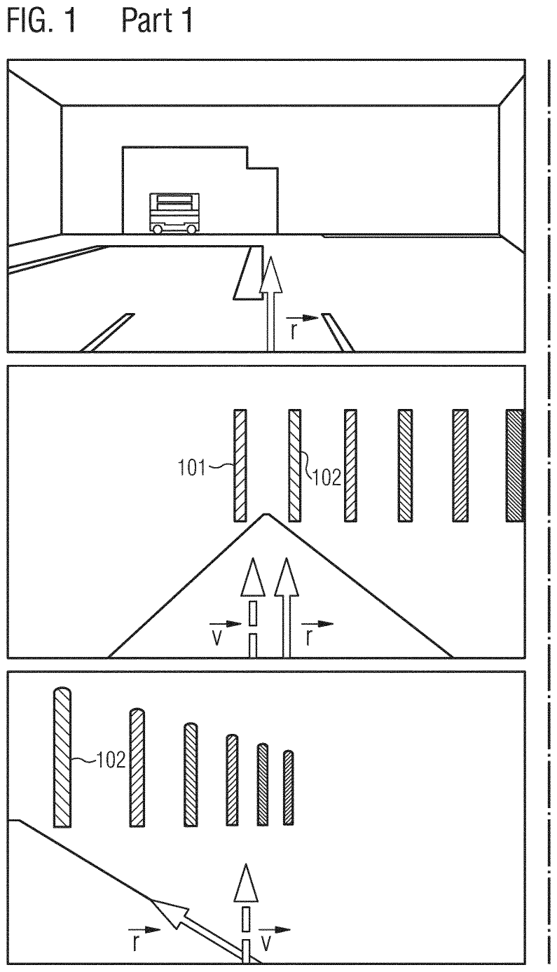

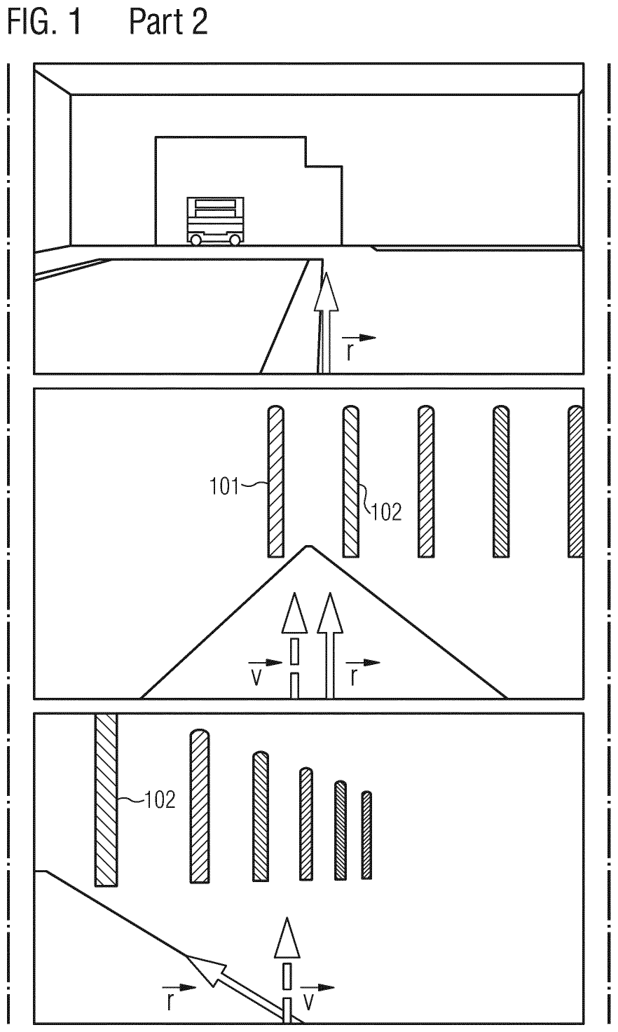

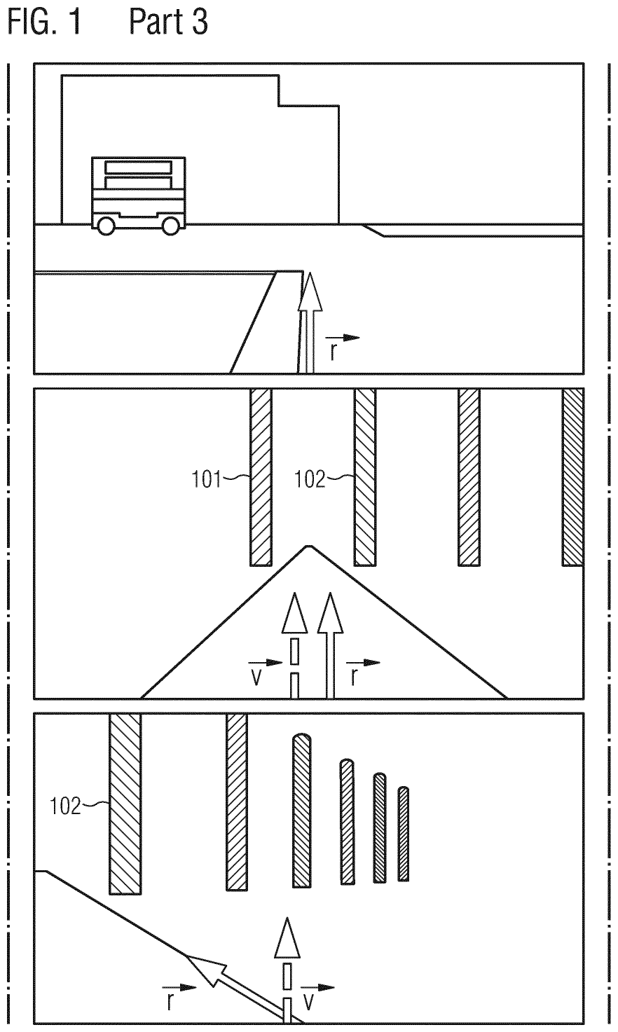

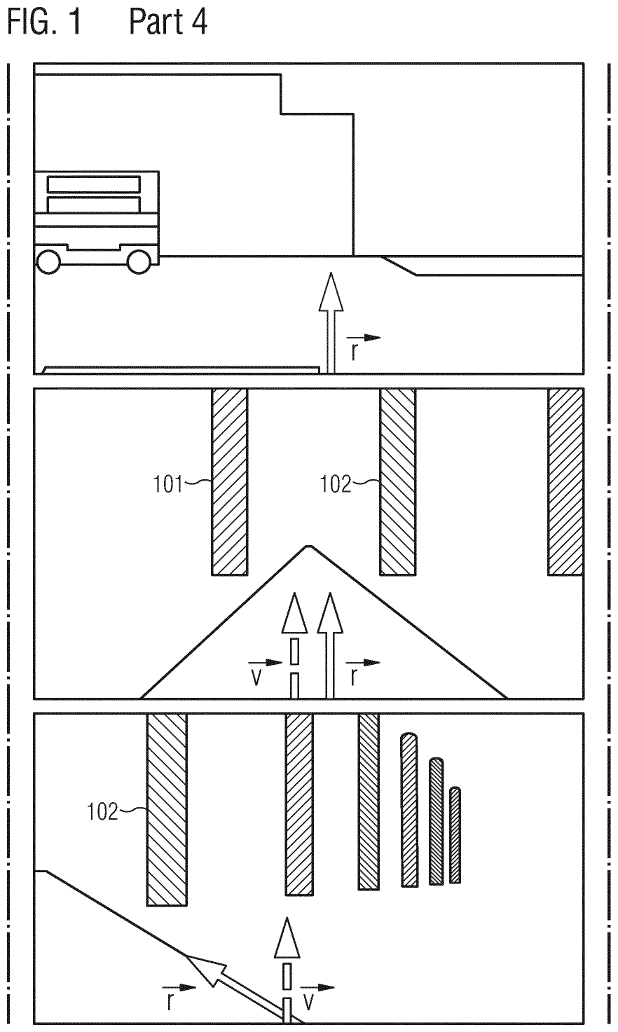

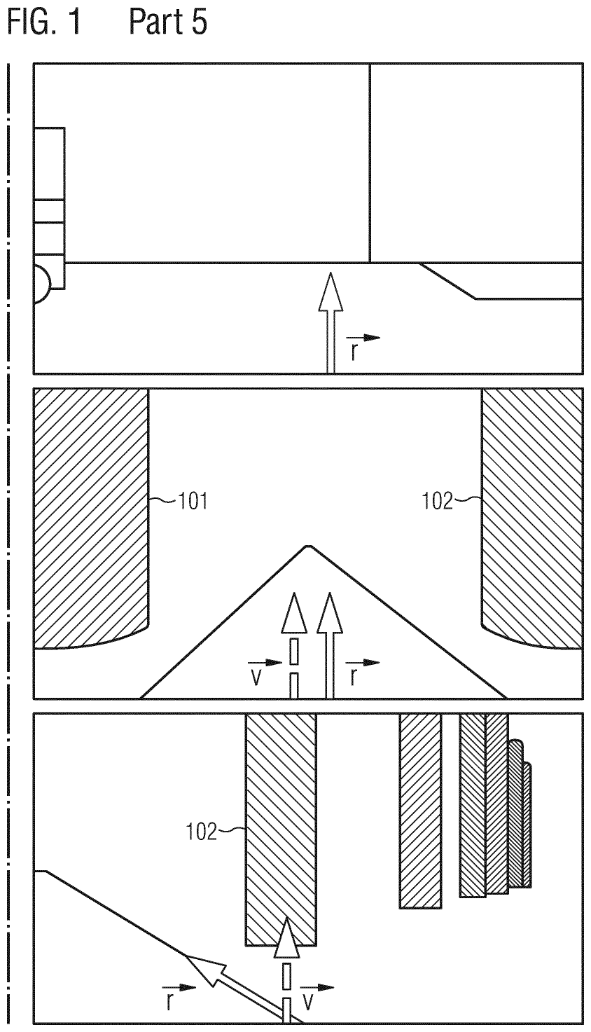

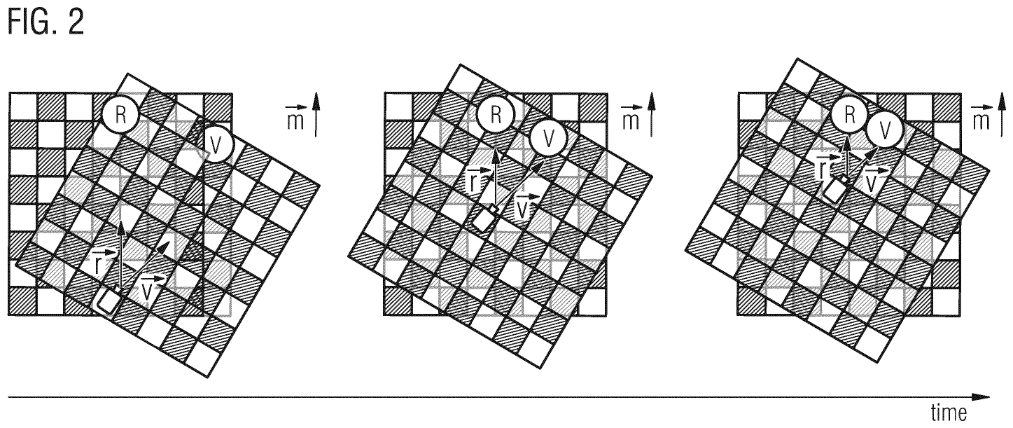

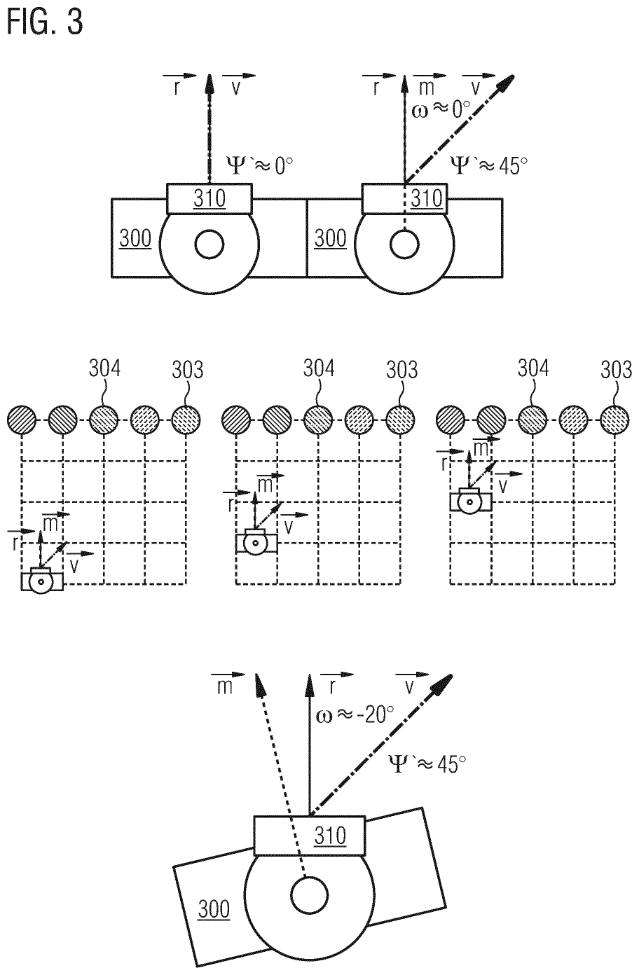

FIG. 3 illustrates different drift scenarios using a top-view onto a user 300. User 300 carries a HMD 310. FIG. 3(a) is a situation with almost no drift (ψ′≈0°). The user's real head orientation \vec{r} is very close to his/her virtual head orientation \vec{v}. Hence movements feel natural as the real head orientation is used to correctly render the VR image. In FIG. 3(b) some drift has accumulated and \vec{v} and \vec{r} differ by about ψ′≈45°. When the user 300 moves in the direction of \vec{m}, s/he recognizes this offset as unnatural/wrong translation of the rendered camera image towards \vec{v}. FIG. 3(c) shows the zoomed-out representation of this situation with the user at the bottom and the pillars from FIG. 1 at the upper end of the grid. The user 300 moves forward in direction Iii, in two steps. \vec{r} is the user's real view direction, \vec{v} is the drift-affected view direction. The user 300 tries to walk towards pillar 303 as the VR display suggests that it is straight ahead. However, the user's head/body is oriented in direction \vec{m}.

What causes motion sickness is that when the user moves straight forward in reality (in direction of \vec{m}) to reach the pillar 303, the VR view shows a sidewards movement, see also the bottom row of FIG. 1. In the third step of FIG. 3(d) the user sees pillar 304 straight ahead in direction \vec{v} as the VR display suffers from the drift. With a small ψ′ the user will not recognize any inconvenience. With a larger ψ′ the user feels as if s/he is pulled away sidewards while approaching the target because the distortion of relative distances affects every object the user sees in the VR. The problem is that \vec{r}′ and hence ψ′ are unknown to the VR system when the head orientation is unknown and that hence the VR system cannot align \vec{v} closer to \vec{r}. Hence, to achieve an acceptable level of immersion a (continuous) adjustment of \vec{v} and a long-time stable heading orientation is needed.

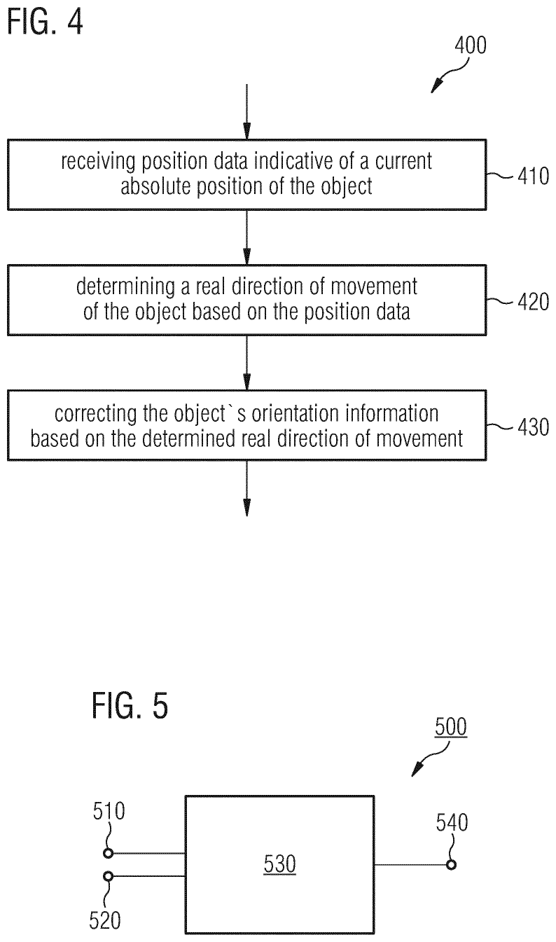

FIG. 4 shows a high level flow chart of a method 400 to achieve this and to correct (inaccurate) orientation information which is based on inertial sensor data from one or more inertial sensors, such as accelerometers and or gyroscopes, mounted to an object. An example of the object could be the user 300 himself or the HMD 310 mounted to the head of the user. The skilled person having benefit from the present disclosure will appreciate that other objects are possible as well, such as animals or vehicles, for example.

Method 400 includes receiving 410 position data indicative of a current absolute position of the object 310. For that purpose the object 310 may generate or cause NP positional data, for example, by means of an integrated GPS sensor. Another option could be to use a Radio-Frequency (RF) NP tracking system. In this case the object 310 could be tracked by means of an active or passive RF position tag attached to the object and emitting RF signals to a plurality of antennas. The object's position can then be determined based on the different time-of-flights of the RF signals to the different antennas. A real direction of movement \vec{m} of the object can be determined 420 based on the position data. The object's orientation information \vec{v} can be corrected 420 based on the determined real direction of movement \vec{m}.

FIG. 5 shows a schematic block diagram of a corresponding apparatus 500 for performing method 400.

Apparatus 500 comprises an input 510 configured to receive position data indicative of a current absolute position of the object 310. Apparatus 500 can further comprise an input 520 to receive inertial sensor data from one or more inertial sensors. Orientation information ii can be derived from the inertial sensor data. Processing circuitry 530 of apparatus 500 is configured to determine a real direction of movement \vec{m} of the object 310 based on the position data and to correct the object's orientation information \vec{v} based on the determined real direction of movement \vec{m}. The corrected orientation information can be provided via output 540.

The skilled person having benefit from the present disclosure will appreciate that apparatus 500 can be implemented in numerous ways. For example, it can be an accordingly programmed programmable hardware device, such as a general purpose processor, a Digital Signal Processor (DSP), a Field Programmable Gate Array (FPGA), or an Application Specific Integrated Circuit (ASIC). In one example, apparatus 500 may be integrated into a HMD 310 for VR applications or another (remote) device controlling the HMD. The HMD may be comprised of a smartphone or another portable device in some examples.

As absolute position tracking is used to generate the (absolute) position data, a solution is to combine the position data or positional tracking information with the relative motion sensors. Assuming that persons look forward in forward movements (ƒ/0, forward at 0 degrees), his/her positions [p₀ . . . pₜ] can be recorded for t time steps. A position trajectory vector \vec{m}=pₜ . . . p₀≈\vec{r} can be extracted from the recorded positions. Thus, determining 420 the real direction of movement \vec{m} can include determining \vec{m} based on position data corresponding to subsequent time instants. We can use \vec{m} to derive an offset to see \vec{v}, FIG. 3(b). Given two dimensions (x, y), we can derive a preliminary real orientation \vec{r′} by:

$$\vec{{r}^{′}} = a tan ( \frac{{p}_{t} ( {y}_{n} ) - {p}_{t} ( {y}_{n} - 1 )}{{p}_{t} ( {x}_{n} ) - {p}_{t} ( {x}_{n} - 1 )} ) .$$

Finally, we can add a correction factor ϕ to correct the coordinate system for the correct quadrant Qᵢ (ϕ∈{Q₁=90°, Q₂=180°, Q₃=270°, Q₄=360° }) of the coordinate system. Thus,

\vec{r}=(\vec{r′}+ϕ)mod(360°).

This basic implementation can estimate correct offsets if the user's head orientation equals his/her movement direction, i.e., if \vec{r}≈\vec{m}. However, in reality this is not always the case and a wrong orientation might be estimated, see FIG. 3(c). If the user looks right by ω=20° (ƒ/20), while the normalization method assumes ƒ/0, this method can fail for the w=20° the user looked to the right. To know if the HMD 310 points towards the movement direction i.e., \vec{r}≈\vec{m}, we could advice the user 300 to look and move forward. But this would be suboptimal as this also induces a lack of immersion. Moreover, as we have no clue about the accumulated drift (and if it is in a critical state for immersion) we would need to trigger the user on an over-regular basis.

Thus, some examples propose to continuously analyze the IMU sensor data and automatically detect ƒ/0 movements to trigger orientation estimation. The skilled person having benefit from the present disclosure will appreciate, however, that also any other predefined head/body relation could be used and trained for correcting the IMU based head orientation. Besides, the automatic movement detection can take care of the maximum tolerated heading drift to keep immersion on a high level. Therefore, some examples monitor the drift permanently and keep it as small as possible.

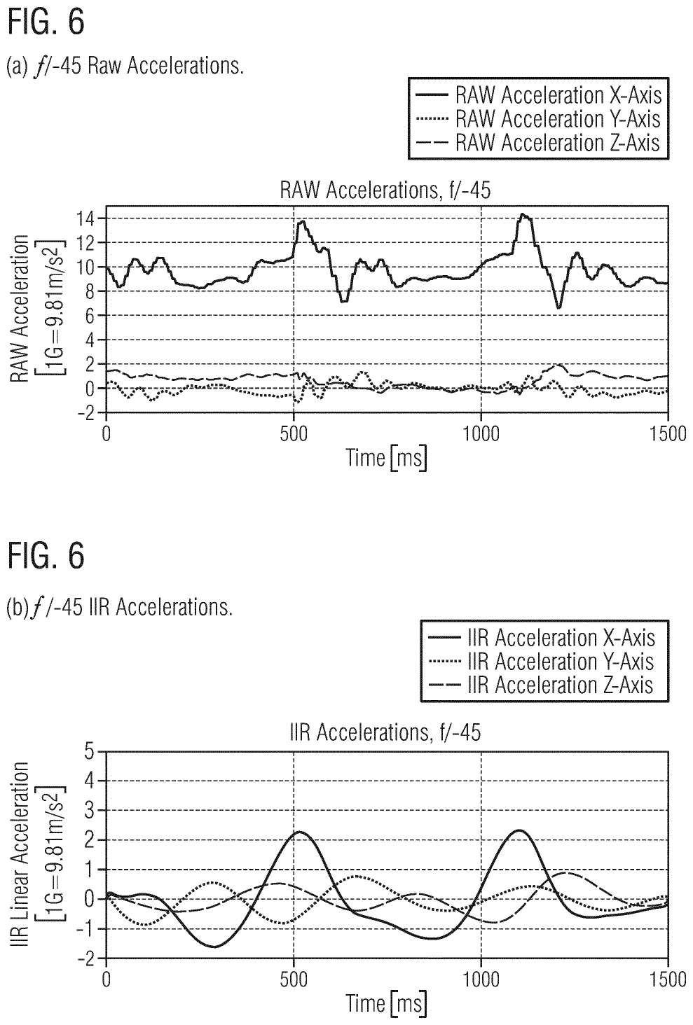

In some implementations, the sensor data comprises 3-dimensional acceleration data and 3-dimensional rotational velocity data. Some of today's low-cost accelerometers track gravity and linear acceleration acc_{raw}=accₗᵢₙ+acc_{grav} at 200 Hz with a maximum of ±16 g, and some gyroscopes track the velocity of rotations at 200 Hz with a maximum of ±2000°/s. FIG. 6(a) shows an example of raw acceleration signal for ƒ/−45. X points upwards, Y points to the left, and Z points to the back of the user. As the raw acceleration signal not only includes linear acceleration but also gravity, the signals can be decomposed in order to get acct. In addition to the noise, the curves have a gravity component in the acceleration signal. This is best seen in the dashed curve for the X-axis that shows that the user's head is moving up and down when s/he is walking (one gait cycle, i.e., two steps shown). How ever, as only the linear acceleration represents real motion in space we need to eliminate the gravity component.

FIG. 6(b) shows linear acceleration after filtering. Some implementations can use a low- and high-pass Infinite Impulse Response (IIR) filter with a Butterworth design as it is fast and reliable after correct preinitialization. The skilled person having benefit from the present disclosure will appreciate that also other filter designs, such as Finite Impulse Response (FIR) filters, for example, may be feasible as well, depending on the signal characteristics and/or the features to be extracted from the sensor signals. An example lowpass filter can compensate for extremely fast head movements and can remove noise with a half-power frequency of 5 Hz, whereas an example high-pass filter can compensate for long-term drift with a cutoff frequency of 40 Hz. The output signal y[n] at sample n for an IIR filter can be written as

$$y [ n ] = \frac{1}{{a}_{0}} ( {\sum }_{i = 0}^{N} {b}_{i} \cdot x [ n - 1 ] - {\sum }_{j = 1}^{M} {a}_{j} \cdot y [ n - j ] )$$

where x can be the raw acceleration, a is the filter coefficient to the feedback filter with filter order M_{low}=3 and M_{high}=1, and b is the filter coefficient to the feed-forward filter with filter order N_{low}=3 and N_{high}=1. Therefore, each filter (LP, HP) can have its own Butterworth filter design (a, b). For uneven (e.g. N=1)

$${a}_{i} = 2 \cdot cos ( \frac{( i - 1 ) \cdot π}{2} )$$

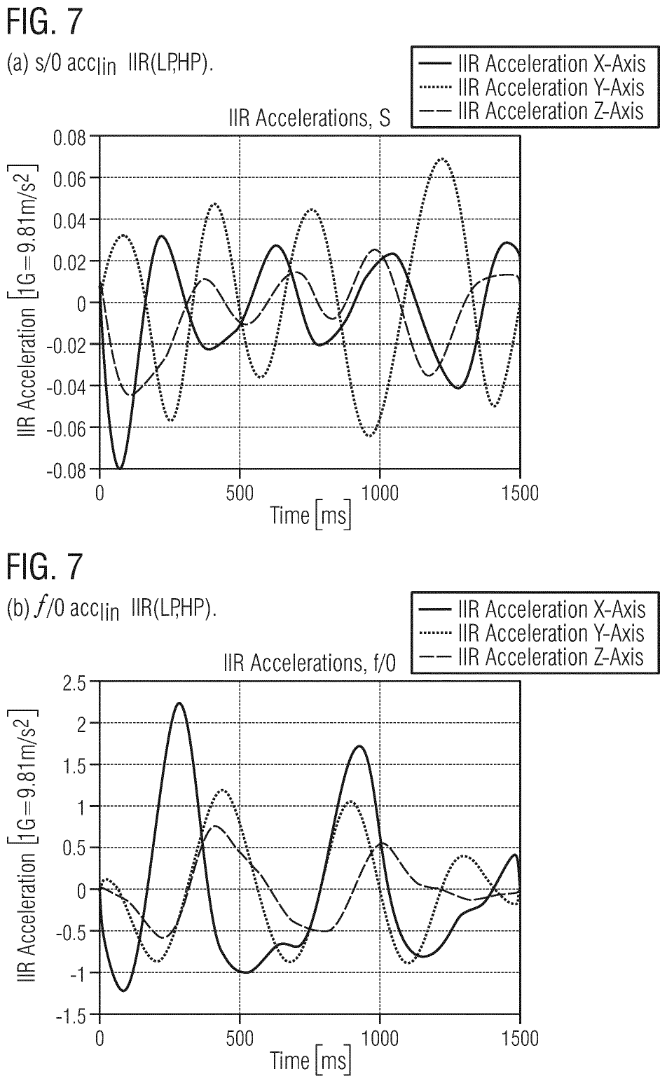

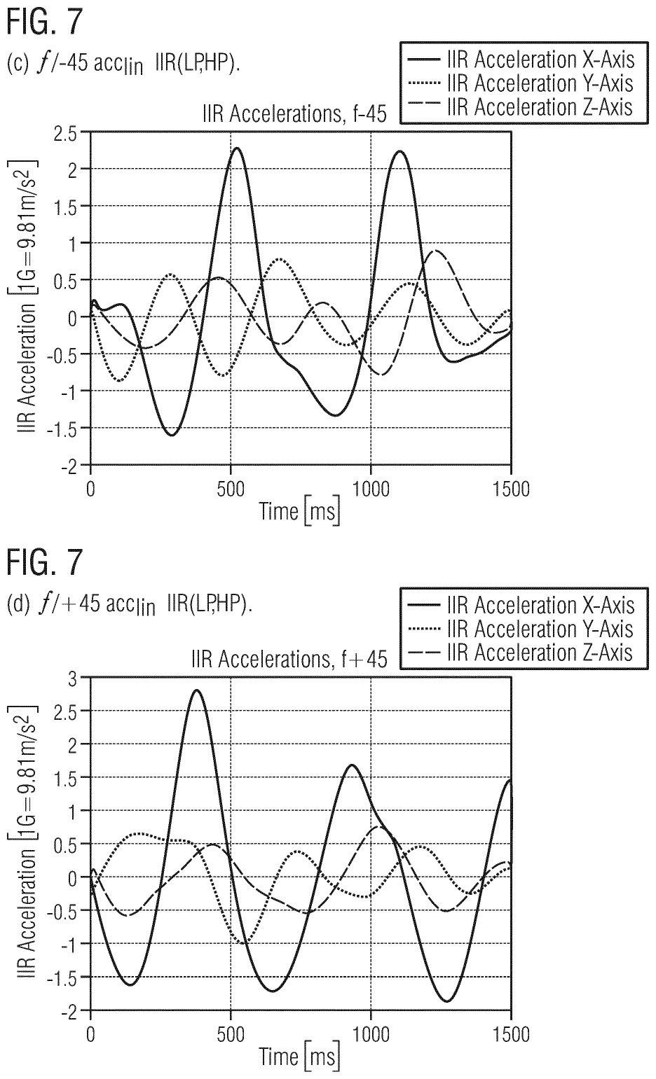

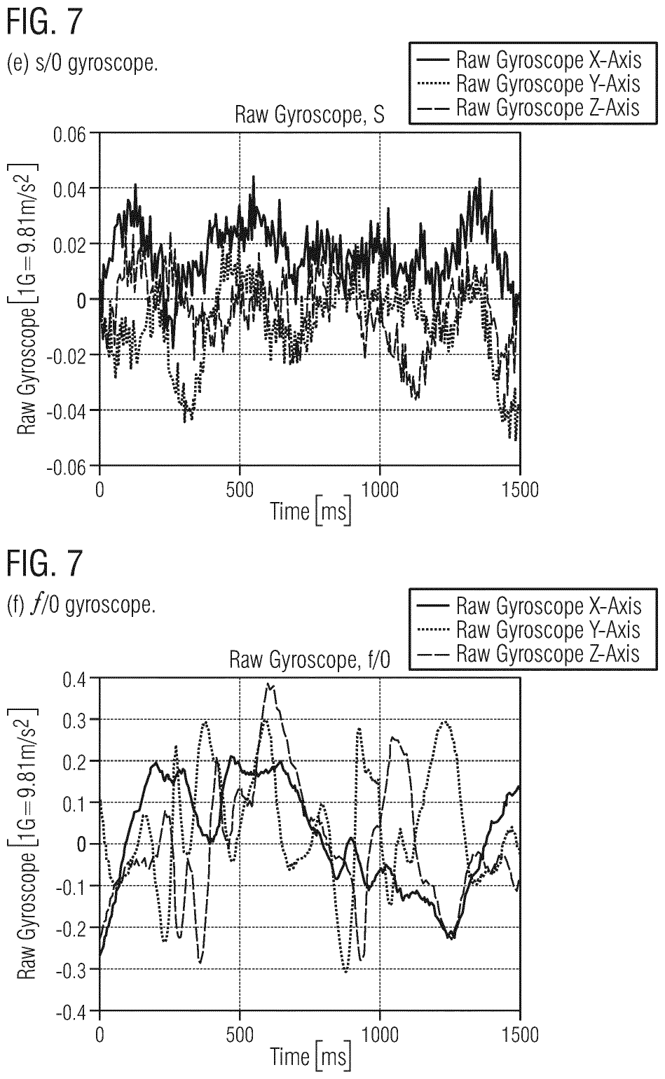

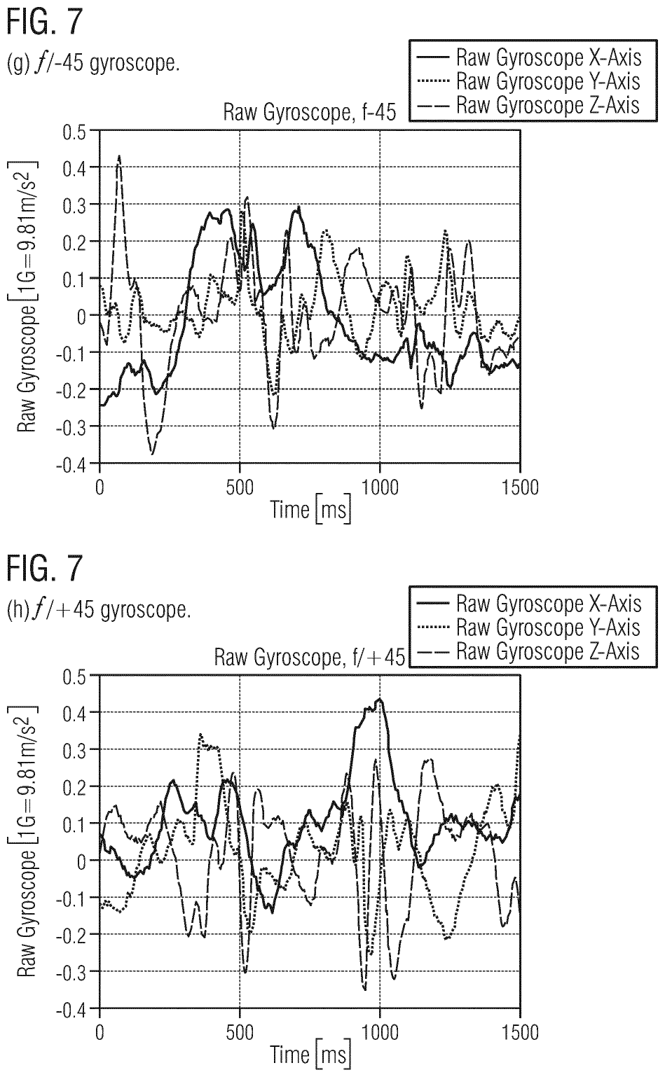

and bᵢ=1; rims. FIG. 7(a) shows the IIR-filtered acceleration while standing (s/0) and FIGS. 7(b)-7(d) show the IIR-filtered acceleration for different movement types and one gait cycle, e.g., a left- and a right-foot step.

Example feature extractions can fuse linear acceleration data with smoothed gyroscope data. Thus, method 400 can optionally further include filtering the (raw) sensor data with a smoothing filter to generate smoothed sensor data. Smoothing of the raw input data while retaining signal characteristics can be achieved by a Savitzky-Golay filter, with frame size F=25 and polynomial order N=3, for example.

$${y}_{j} = {\sum }_{i = \frac{1 - F}{2}}^{\frac{F - 1}{2}} {C}_{i} \cdot {y}_{i + j} subject to$$

$$\frac{F + 1}{2} \leq j \leq n - \frac{F - 1}{2} and$$

$$y = {a}_{0} + {a}_{1} \cdot z + {a}_{2} \cdot {z}^{2} + … + {a}_{N} \cdot {z}^{N} with number n of points j .$$

In a training-phase the input data can be sliced in windows of constant sample number. The data can be analyzed by a motion state module that can detect motions in the acceleration data by min/max-thresholding acceleration peaks and the time between them. By specifying the number of zero-crossings and their direction we can deduce additional information (step with foot∈[l, r]) about the current window. In a live-phase data can be processed in sliding-windows. In contrast to commonly used window overlaps of 50% a sliding window approach can be used (as this can also be beneficial for auto motion detection). The length of the sliding window can adapt to available CPU time and required response time by a number of future samples ω_{wait} according to physical limitations to create the new data frame upon. However, the window length should be long enough to capture the sensor data of an activity completely. As a human performs a minimum of 1.5 steps/s (while walking at 1.4 m/s in reality, users tend to walk slower in VR: slow 0.75 m/s, normal 1.0 m/s, fast 1.25 m/s) a minimal length of 1000 ms can be used to yield high confidence.

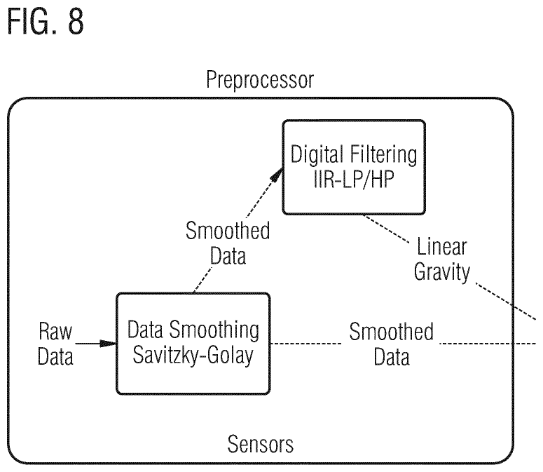

The aforementioned example preprocessing of the raw inertial sensor data is summarized in FIG. 8.

Raw sensor data (e.g., acceleration data and/or smoothed gyroscope data) can be smoothened by a smoothening filter 810 (e.g., Savitzky-Golay Filter) without significant feature loss. In order to isolate unwanted signal components (such as gravity, for example) the (smoothened) sensor data can be LP and/or HP filtered 820. The filtering can relate to both acceleration data and gyroscope data or only to one of them. The preprocessed sensor data can then be used for data compression. One example of data compression is to extract one or more statistical and/or heuristic features from the sensor data to generate sensor data feature vectors. It is proposed to use a minimum number of statistical and/or heuristic features to save performance while still providing highly confident results. Basically, the features can be selected to maximize variance between and minimize variance within predefined movement classes. Table I below introduces some features commonly used and shows the degree of freedom and number of features necessary.

TABLE 1
FEATURES OFTEN USED FOR IMU CLASSIFICATION.

| | | Axes | |
|---|---|---|---|
| Feature | Description | [x, y, z] | # |
| Mean | Mean value | x, y, z | 3 |
| MAD | Median absolute value | x, y, z | 3 |
| Minimum | Smallest value of the vector | x, y, z | 3 |
| Maximum | Largest value of the vector | x, y, z | 3 |
| StD | Standard deviation and variance | x, y, z | 3 |
| PCA | Principal Component Analysis | x, y, z | 3 |
| DCT | Discrete Cosine Transform | x, y, z | 3 |
| SMA | Signal Magnitude Area | x, y, z | 3 |
| Entropy | Signal Entropy | x, y, z | 3 |
| AR_{coeff} | Autoregression coefficients | x, y, z | 3 |
| Energy | Average sum of the squares | x, y, z | 3 |
| Correlation | Correlation coefficient between | {x, y}, | 1 |
| | signal axes | {x, z}, | |
| | | {y, z} | |
| Skewness | Freq. signal Skewness | x, y, z | 3 |
| Kurtosis | Freq. signal Kurtosis | x, y, z | 3 |
| Angle | Angle between two axes | θ (x, y), | 1 |
| | | θ (x, z), | |
| | | θ (y, z) | |
| VeloDir | Vector direction of the angular velocity | vₓ, v_{y}, v_{z} | 3 |
| Freqₘᵢₙ | Smallest freq. component | x, y, z | 1 |
| Freqₘₐₓ | Largest freq. component | x, y, z | 1 |
| Freqₘₑₐₙ | Average freq. component | x, y, z | 1 |

One example uses 18 features for the data: 3 axes accelerometer and gyroscope, each represented by mean, StD and PCA features. Thus, in some examples compressing the sensor data can comprise extracting a mean value, standard deviation, and can comprise a Principal Component Analysis (PCA) of the sensor data.

Mean.

The mean

$$( μ = \frac{1}{N} \cdot {\sum }_{i = 0}^{N} X ( i ) )$$

feature value per axis, with the number of samples N and the input data X.

StD.

The standard deviation

$$( φ = \sqrt{\frac{1}{N - 1} \cdot {\sum }_{i = 0}^{N} {\vert X ( i ) - \vert}^{2}} )$$

value based on the variance (ϕ²), with mean (μ), the number of samples N and signal data X.

PCA.

The score values provided by PCA can be obtained based on a singular value decomposition (SVD). Given an arbitrary matrix X of dimension n×p (matrix of n observations on p variables measured about their means), we can write matrix X=ULA′ where U is a (n×r) unitary matrix and A′ is (p×r) is the adjunct of an unitary matrix A. Each matrix with orthonormal columns so that U′U=Iᵣ and A′A=Iᵣ. L is a (r×r) diagonal matrix (L=Σ, with its singular values on the diagonal) with the rank r of our arbitrary matrix X. Element uᵢₖ is the (i, k)th element of U and aⱼₖ is the (j, k)th element of A.

$${l}_{k}^{\frac{1}{2}}$$

is the (k)th element of the diagonal matrix L:

$$X = {ULA}^{′} = X \cdot {\sum }_{k = 0}^{p} {a}_{k} \cdot {a}_{k}^{′} = {x}_{ij} = {\sum }_{k = 0}^{r} {u}_{ik} {l}_{k}^{\frac{1}{2}} {a}_{jk}$$

Xaₖ=Uᵤ_{ᵢₖ}Lₗ_{ₖ} represents the vector holding the kth

$${z}_{ik} = {u}_{ik} {l}_{k}^{\frac{1}{2}} ,$$

scores with i=1, 2, . . . , n and k=1, 2, . . . , r. In the context of a SVM classifier the determined PC scores zᵢₖ represent the perpendicular distances of the observations n from the best-fitting hyperplane.

In some examples, the method includes classifying a relation between the real orientation of the object \vec{r} and the object's real direction of movement \vec{m} based on the compressed sensor data or the sensor data feature vectors. Optionally, a confidence level can be generated with respect to the classification result. To classify movement types several classifiers can be used alternatively or in combination, such as, for example, Decision Trees (DT), cubic K-Nearest Neighbor (K-NN), and cubic Support Vector Machines (SVM). That is to say, classifying the relation between the object's real orientation \vec{r} and the object's real direction of movement \vec{m} can be performed using one or more classification algorithms.

1) Decision Tree: Here a Classification And Regression Tree (CART) can be used to achieve reasonable results with maximum splits of 100 (complex tree) and a minimal number of leafs of 1. The less CPU-intensive Gini diversity index I_{G} can be used as split criterion:

I_{G}=1−Σᵢ₌₁^{C}p(i|t)²,

subjecting node t∈S_{C-1} with S_{C-1}={x:x∈[0,1]ⁱ, Σᵢ₌₁^{C}xᵢ=1} and observed fractions p(i|t) of all classes C with class i that reaches the node t. Additionally, we can save performance as we use CART without surrogate decision splits as we do not miss any data in the classification process. We can prune the tree until the number of parents for each leaf is greater than 10 at the Gini impurity criterion I_{G}. We can allow leave merging of leafs (child nodes C) that both originate from the same parent node (P) and that yield a sum of risk values (Rᵢ) that are greater or equal to the risk related to the parent node (RP): (Σᵢ₌₁^{n=|C|}Rᵢ)≥R_{P}.

2) K-Nearest Neighbor: Some implementations may also use a cubic K-Nearest-Neighbor classifier with a distance parameter (k=3) and a distance function (X×Y)ⁿ→(X→Y). As an example, the cubic Minkowski distance metric can be chosen which holds instance x, label y, distance weight ωᵢ, and dimensionality m:

$${d}_{k} ( x , y ) = {ω}_{i} ( \sqrt[k]{{{\sum }_{i = 1}}^{m} {\vert {x}_{i} - {y}_{i} \vert}^{k}} ) ,$$

where x, y∈X= [symbol] ^{m}. Ties that occur when at least two classes have the same number of nearest points among the k nearest neighbors can be broken based on their smallest index value. Instead of a less accurate unmodified K-dimensional tree, a CPU-intensive but sufficient accurate exhaustive (brute force) search algorithm can be used. The distance weights ωᵢ are the squared inverse of the instances x and labels y: ωᵢ=(((x−y)^{T}Σ(x−y))²)⁻¹. The dimensionality of neighbors m=10 can provide reasonable results. A data standardization approach can be used that rescales data to improve situations where predictors have widely different scales. This can be achieved by centering and scaling each predictor data by the mean and standard deviation.

3) Support Vector Machine: Another example implementation uses a cubic SVM with a homogeneous polynomial kernel K(x_{q}, xᵢ)^{d}=ϕ(x_{q})^{d}ϕ(xᵢ)^{d} applied to input sensor data feature vectors X(x_{q}, xᵢ) with space mapping function ϕ(X) and order d. We define training vectors t in training space Rⁿ with xᵢ∈Rⁿ with i=1, t as being divided into classes and a label vector y∈R^{t} that yᵢ∈{1, −1} holds. The SVM can solve the following optimization problem, subject to

(i) yᵢ(w^{T}ϕ(xᵢ)+b)≥1−ξ) and

(ii) ξᵢ≥0 and i=1, . . . , t with ϕ(xᵢ) mapping xᵢ into a higher-dimensional space, with regularization parameter (box constraint level) C and with slack variable ξᵢ:

½∥w^{T}w∥+CΣᵢ₌₁^{t}ξᵢ,

The solution of this optimization provides an optimal normal vector (w) to the hyperplane that satisfies w=Σᵢ₌₁^{t}yᵢαᵢϕ(xᵢ) with weight variable αᵢ. Finally, the decision function ƒ(x_{q}) for a feature vector x_{q} holds:

ƒ(x_{q})=sgn(w^{T}ϕ(x_{q})+b)=sgn(Σᵢ₌₁ⁿαᵢyᵢK(x_{q},xᵢ)+b)

An example SVM classifier can use a cubic (d=3) kernel function K(x_{q}, xᵢ)=(1+γ·x_{q}^{T}xᵢ)^{d} to be able to separate non-linear features with C=1 whereas the kernel scale γ=4. The hyperparameters can be obtained by a 10-fold cross validation based on the training data (70%). The cross validation determines the average error over all testing folds (10 divisions) which results in an accuracy overview. A multiclass SVM or a One-vs-All SVM type can be used to provide multiclass classification.

Each of the mentioned example predictors or classifiers (DT, k-NN and SVM) can estimate a class label and its probability or confidence. In some examples, the class labels can be estimated with a rate or frequency higher than a maximum frequency component of the object's movement. For example, during the time it takes a human to turn his head from left to right, numerous class label estimates can be predicted, each with a related probability/confidence ζ. Optionally, the confidences ζ that are provided by our trained classifiers can be further improved by relating them over time and/or considering human-centric motion behavior. In other words, a present confidence of an estimated class label output can be verified by taking into account previous confidences of previous class label outputs or class label hypothesizes and/or by taking into account one or more predetermined physical properties or limitations of the object, in particular limitations of human motion (e.g. head turn rate). For example, a current confidence of a current most probable class label estimate can be compared with one or more previous confidences of previous class label outputs or a mean value thereof. In more complex scenarios, for example, when there are numerous different class labels, also more complex models can be employed, such as Hidden Markov Models (HMMs), for example. There, not only confidences of previous actual class label outputs but also confidences of previous class label hypothesizes corresponding to numerous different class labels can be taken into account.

In some examples, we can predefine the amount s of historical confidences ζ_{H} we want to consider. Hence, the classifier can predict confidences at time ζ(tᵢ) which can be compared to previous (historical) confidences ζ_{H} at times tᵢ∈[tₙ₋ₛ, . . . , tₙ]. A starting probability can be provided to the first confidence observation P(ζ_{H}, tᵢ=0). As every confidence depends on the probability of its ancestors P(ζ_{H}, tₙ₋ₛ) the probability of the current confidence can be determined in respect to n-s past confidences. Therefore, we can significantly improve the trustworthiness of the current confidence and also identify single outliers. The probability of the current confidence P(ζ, tₙ) and the current confidence ζ(n) based on all n, with s>0 of historic confidences are:

$$P ( {ζ}_{H} , {t}_{n} ) = \frac{1}{s} ( ( {\sum }_{i = n - s}^{s} P ( {ζ}_{H} , {t}_{i} ) ) + ζ ( {t}_{n} ) )$$

with initial historic probability at tᵢ=0 with P(ζ_{H}, tᵢ)=1.0:

ζ_{H}(tᵢ)=P(ζ_{H},tᵢ)·ζ(tᵢ)

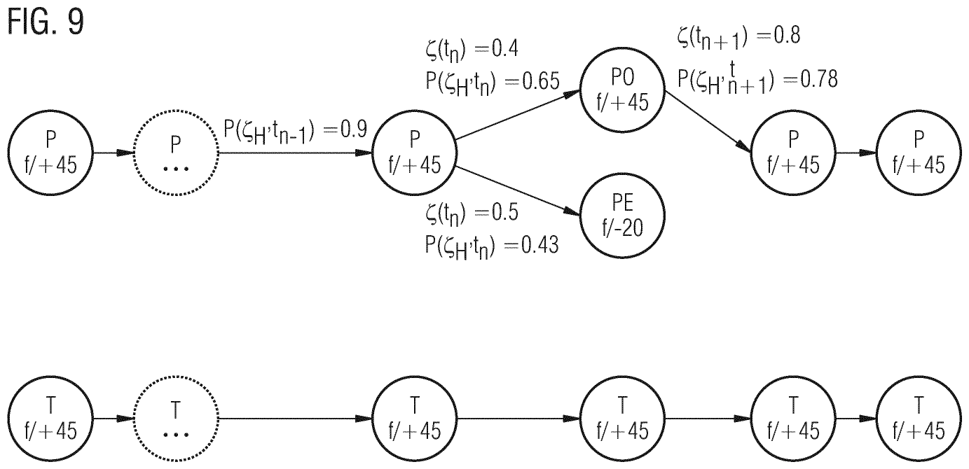

FIG. 9 shows how an example optimization process PO compensating false predictions PE (upper portion) based on probabilities p in comparison to ground truth T (lower portion). In machine learning, the term “ground truth” refers to the accuracy of the training set's classification for supervised learning techniques. In comparison to human-centric motion a prediction of ƒ/+45 at tₙ is false if we predicted a trustworthy ƒ/−45 at tₙ₋ₛ, as humans are not able to rotate their head within two predictions (dt≈ω_{watt}·5 ms.

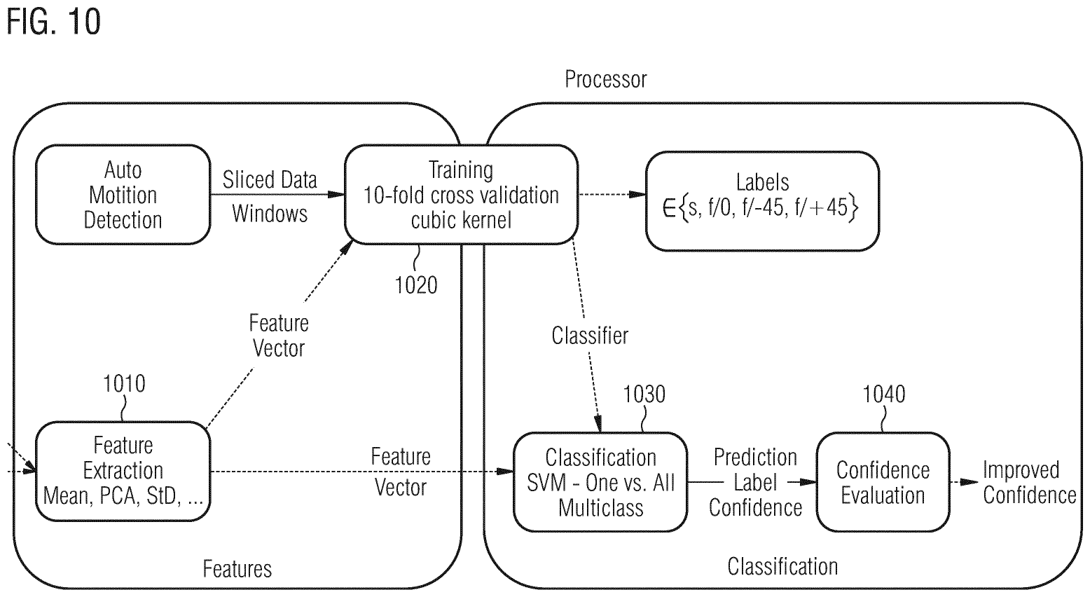

A summarizing overview of the aforementioned processing acts is described in FIG. 10. The processing of the preprocessed sensor data (see FIG. 8) can be divided into two phases:

(i) Training

(ii) Live

In both cases feature vectors can be extracted from the input data (see reference numeral 1010). During the training phase 1020 smoothened sensor data can be provided to the classifier (e.g., SVM) 1030. The smoothened sensor data can be analyzed by feature extraction algorithms 1010 in order to lift the input data into their feature space. The extracted features can be used as inputs to train or optimize the classifier 1030. During the live phase the trained classifier 1030 can predict a motion class or label together with its confidence. For example, the classifier 1030 gets an inputs signal corresponding to a ƒ/0 movement and predicts the label ƒ/0 with a confidence of 90%. The classifier can use a so-called cross-fold validation principle to judge how well it can classify the input data. With a probabilistic assumption of human motion over time the result can further be improved, since a human mostly views into the direction (s)he is moving. Also a human cannot change his/her head orientation from left to right (or vice versa) within two predictions, e.g. ([5, . . . , 20] ms). Thus, probabilistic dependencies over time and/or history of predicted confidences can be used to predict the current probability of the predicted confidence and to correct the label if necessary (see reference numeral 1040).

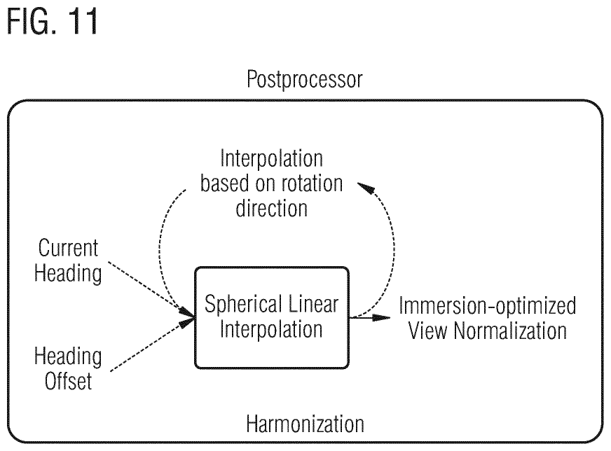

An example view adaptation (post-)procedure is illustrated in FIG. 11. After the classification of the relation between the object's real orientation and the object's real direction of movement has been predicted we know how the object (e.g., the user's head or HMD) is oriented with respect to the movement direction. If we know that the head is oriented in line with the movement direction we can correct the sensor based virtual view by corresponding the object's virtual orientation with the object's real direction of movement. Since a straightforward correction can lead to so-called motion sickness, a more mature solution is proposed. It is proposed to correct errors if they exceed a specific non-immersive threshold and to slice the error in smaller immersive portions and to iteratively apply these immersive portions over time and along a current rotation.

Some examples estimate the head orientation using a 6 degree of freedom (DOF) sensor and implement a complementary filter. This filter also accounts for static and temperaturedependent biases as well as additive, zero-mean Gaussian noise. We define the current gyroscope based angular velocity ω_{x,y,z}=ω_{x,y,z}+b+n, with static and temperature depended bias b and additive, zero-mean Gaussian noise n. Subjecting the filter coefficient α and current accelerometer data a_{x,y,z} and converting radians to degrees (180/π) we can determine the roll ϕ and pitch θ orientations:

$$φ = α \cdot ( φ + {w}_{z} \cdot Δ t ) + ( 1 - α ) \cdot \frac{180 °}{π} \cdot ( - a tan 2 ( {a}_{x} , {a}_{y} ) )$$

$$θ = α \cdot ( θ + {w}_{x} \cdot Δ t ) + ( 1 - α ) \cdot \frac{180 °}{π} \cdot ( - a tan 2 ( {a}_{z} , \sqrt{{a}_{x}^{2} + {a}_{y}^{2}} ) )$$

The roll ϕ and pitch θ orientation can be estimated stable over long-time periods. The yaw orientation can be determined by fusing accelerometer and gyroscope (neglecting the magnetometer). An error of the object's (yaw) orientation information can be corrected incrementally or iteratively. For example, a spherical linear interpolation (SLERP) mechanism can be applied that linearly interpolates the determined heading orientation error ψₑᵣᵣ into the current view orientation ψ_{cur} of the user. The interpolation approximates the current drift ψₑᵣᵣ into the users view by applying a small immersive portion of the offset ωᵢₘₘ·ψₑᵣᵣ, while the sign (sgn) of current rotation is sgn(ψ_{cur})=sgn(ψₑᵣᵣ). The immersion can be optimized adjusting ωᵢₘₘ (number of degrees per second) per iteration. The corrected heading orientation based on an initial head orientation with yaw ψᵢₙ can be written as:

$$ψ = α \cdot ( {ψ}_{cur} + {w}_{y} \cdot Δ t ) + ( 1 - α ) \cdot \frac{180 °}{π} \cdot {ψ}_{in} + ( Δ t \cdot {ω}_{imm} \cdot {ψ}_{err} )$$

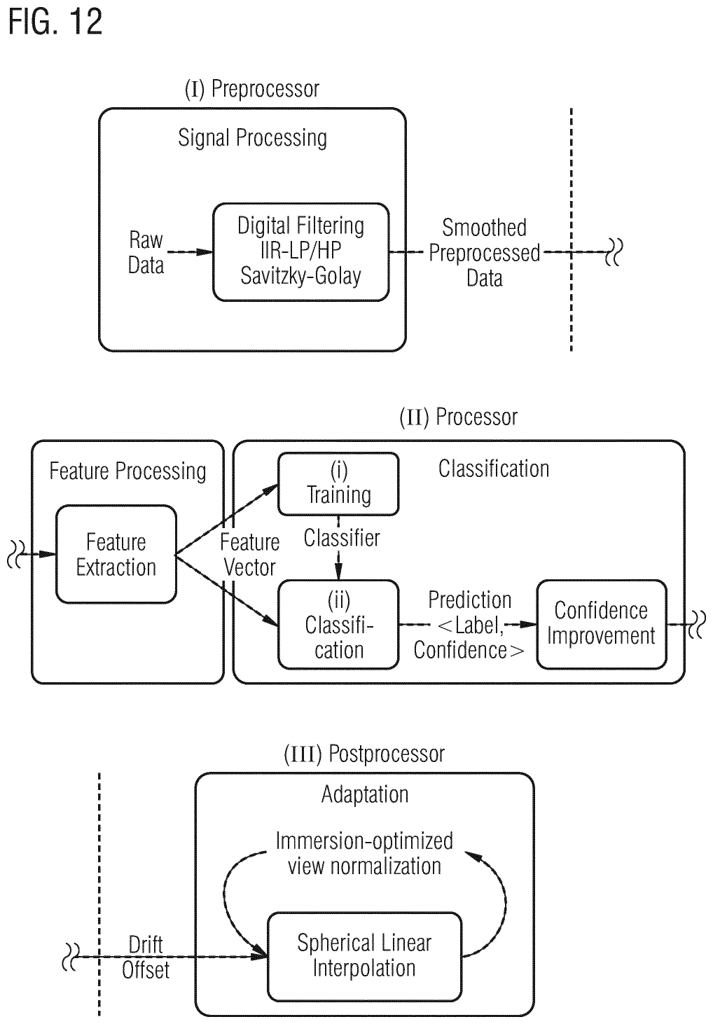

A complete example orientation correction procedure is summarized in FIG. 12.

Some implementations propose to use supervised machine learning to classify various ranges of ω. If among all the ranges the ω=0°-moment class has the highest probability, we have detected a \vec{m}=\vec{r}-moment. From the input data of the IMU (accelerometer and gyroscope) we can extract the linear acceleration component, i.e., the movement energy in every direction axis and can define specific features that characterize and represent a certain range of ω. We can use these features to train our classificator for all the ω-classes a-prioi on pre-recorded and labeled training data. At runtime, we can use these models to classify co on live sensor data, and hence detect ω=0°-moments if the corresponding classifier yields the best fit/highest confidence.

FIG. 12 outlines the basic structure of an example processing pipeline. First, we can smooth the raw accelerometer and gyroscope sensor signals with digital filters. In a training phase we can use such signals to extract features for known ranges of ω on labeled training samples to train the classificator. A fine-grained resolution of ω-moments can improve the classification and its confidence. However, this is a trade-off as we need more data for training and more CPU cycles at runtime for classification if we use more classes. At runtime, the trained classifier can processe the features of (smoothed) unknown signals and return the best-fitting ω-range class and its classification confidence. To increase the classification rate we can use the classifier's estimated confidences and include physical limitations (e.g., human-centric motion limitations such as the impossibility to turn the head by 90° in 1 ms) and keep previous confidences. In ω=0°-moments we can determine the head orientation drift and can use a spherical linear interpolation to reduce drift in an immersive way so that users do not see any adaptation. In other words, In order to determine when \vec{r}≈\vec{m}, absolute position data can be used to determine \vec{m}. In order to determine \vec{r}, some examples propose to classify the head's orientation with respect to the body's movement direction \vec{m}. In a training phase of a classifier (e.g., SVM) relative sensor data corresponding to known movement states (relation between the head's real orientation and the user's real direction of movement) are noted and used for training. The trained classifier can now classify unknown sensor data and to provide a notation and confidence. An adequate choice of notation can thus lead to the knowledge when \vec{r}≈\vec{m}. For example, the notations “head/left”, “head/right”, “head/straight” can be used, wherein “head/straight” corresponds to \vec{r}≈\vec{m}. In order to optimize the classification it is proposed to generate feature vectors aiming to reduce computational complexity and optimize classification. Raw sensor data typically comprises redundancies that can be avoided or reduced with adequate feature extraction. A so-called feature space mapping can help to lift features from the real world into a new dimension. A mapping function can be chosen such that the feature vectors can be separated and classified well. The choice is a compromise between high confidence and low performance.

While conventional concepts lack a long-time stable heading bias estimation and hence decrease immersion, some examples of the present disclosure propose to combine signal processing, feature extraction, classification and view harmonization that can enable immersive head orientation estimation.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computerexecutable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units, e.g. implemented in Smartphones, programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A method for correcting orientation information based on inertial sensor data from one or more inertial sensors mounted to an object, the method comprising:
receiving position data indicative of a current absolute position of the object;
determining a direction of movement of the object based on the position data; and
correcting the object's orientation information based on the determined direction of movement,
wherein correcting the object's orientation information comprises
estimating, based on the inertial sensor data, a relation between a real orientation of the object and the object's direction of movement; and
if the estimated relation indicates that the object's real orientation corresponds to the object's direction of movement,
correcting the object's orientation information based on the determined direction of movement.

2. The method of claim 1, wherein correcting the object's orientation information comprises corresponding the object's orientation information with the object's direction of movement.

3. The method of claim 1, further comprising
filtering the sensor data with a smoothing filter to generate smoothed sensor data.

4. The method of claim 1, further comprising
filtering the sensor data with a low pass filter and/or a high pass filter.

5. The method of claim 1, further comprising
compressing the sensor data.

6. The method of claim 5, wherein compressing the sensor data comprises extracting one or more statistical and/or heuristic features from the sensor data to generate sensor data feature vectors.

7. The method of claim 5, wherein compressing the sensor data comprises extracting a mean value, standard deviation, and comprises a principal component analysis of the sensor data.

8. The method of any of claim 5, further comprising
classifying a relation between a real orientation of the object and the object's direction of movement based on the compressed sensor data and generating a confidence with respect to the classification result.

9. The method of claim 8, further comprising verifying the confidence based on previous confidences and/or predetermined physical properties or limitations of the object, in particular limitations of human motion.

10. The method of claim 8, wherein classifying the relation between the object's real orientation and the object's real direction of movement is performed using one or more classification algorithms.

11. The method of claim 10, wherein the one or more classification algorithms comprises a support vector machine.

12. The method of claim 1, wherein an error of the object's orientation information is corrected incrementally.

13. The method of claim 12, wherein the error is corrected based on spherical linear interpolation.

14. The method of claim 1, further comprising
training a supervised learning model for classifying a relation between a real orientation of the object and the object's direction of movement based on training sensor data corresponding to a predefined relation between a predefined real orientation and a predefined direction of movement of the object.

15. The method of claim 1, wherein
the object's orientation information is indicative of rotational orientation around the object's yaw axis.

16. The method of claim 1, wherein
the real direction of movement is determined based on position data corresponding to subsequent time instants.

17. The method of claim 1, wherein
the sensor data comprises 3-dimensional acceleration data and 3-dimensional rotational velocity data.

18. An apparatus for correcting orientation information based on inertial sensor data from one or more inertial sensors mounted to an object, the apparatus comprising:
an input configured to receive position data indicative of a current absolute position of the object;
processing circuitry configured to determine a direction of movement of the object based on the position data and to correct the object's orientation information based on the determined direction of movement,
wherein the processing circuitry is configured to estimate, based on the inertial sensor data, a relation between a real orientation of the object and the object's direction of movement; and
if the estimated relation indicates that the object's real orientation corresponds to the object's direction of movement,
correct the object's orientation information based on the determined direction of movement.
